(19) United States
(12) Patent Application Publication
(10) Pub. No.: US 2017/0199980 A1
(43) Pub. Date: Jul. 13, 2017

(54) SAFETY PLAN APPLICATION SYSTEMS

(71) Applicant: PATRICIA ERICKSON, WINNETKA, IL (US)

(72) Inventor: PATRICIA ERICKSON, WINNETKA, IL (US)

(21) Appl. No.: 15/405,299

(22) Filed: Jan. 12, 2017

Related U.S. Application Data
(60) Provisional application No. 62/277,798, filed on Jan. 12, 2016.

(51) Int. Cl. G06F 19/00; G06F 17/30; G06Q 50/18

(52) U.S. Cl. CPC G06F 19/3456; G06F 19/3481; G06F 19/325; G06F 19/3418; G06Q 50/18; G06F 17/30312; G06F 19/322

(57) ABSTRACT

A safety plan application system for a convenient way for mentally handicapped patients, doctors, and caregivers to organize and store a patient's information as well as track medication usage and exercise. The application also includes contact information for critical caregivers and people who are able to make medical decisions as well as store favorite quotes, books, music, movies, and other personal preferences. The safety plan application process helps doctors view trends and analyze activity to discover when patients feel their best during their treatment program. The information is stored on an on-line service so that appropriate parties can log in and analyze data at any given time through a smart device or computer with the installed safety plan application.

### CROSS-REFERENCE TO RELATED APPLICATION

The present application is related to and claims priority from prior provisional application Ser. No. 62/277,798, filed Jan. 12, 2016 which application is incorporated herein by reference.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of mental health and more specifically relates to monitoring, managing and logging a user with mental illness.

2. Description of Related Art

Caring for and treating mentally handicapped individuals is a challenging endeavor. Mentally handicapped individuals need special treatment and medication. The treatment process involved in taking care of such individuals varies from patient to patient. No two patients have the same personality or manner in which certain mental conditions affect them. A treatment for one individual may be detrimental to another. Professionals directly involved in treatment have to design a unique treatment plan for each patient separately. Some treatments involve extensive medication management where others simply need therapeutic counselling. Regardless of the method of treatment, extensive records need to be kept.

Records are necessary to the treatment process, and in dealing with mentally handicapped individuals, many agencies keep medical records. Some records include diagnoses, treatment plans, goals, home visit evaluations, counselling coping skills outline, and the like. It is easy for a single mentally handicapped individual to accumulate an extensive record history at several locations. Keeping these records readily available to all parties involved in the care of the individual is extremely difficult, and often, crucial information can be lost or not provided. In rare occasions when dealing with medications, this may be fatal due to allergies to medication or providing medication to an individual who should be under a suicide watch for example. The need for all treatment and medical history to be readily available to all individuals involved in the treatment of a mentally handicapped individual is vital. Therefore, a suitable solution for the electronic distribution and sharing of treatment records between caregivers and physicians is desired.

Several attempts have been made to solve the above-mentioned problems such as those found in U.S. Pub. No. 2011/0225007 to Gerald A. Theis; U.S. Pat Nos. 5,867,821 to Douglas J. Ballantyne et al; and 8,500,635 to Ran Zilca et al. This art is representative of mental health. However, none of the above inventions and patents, taken either singly or in combination, is seen to describe the invention as claimed.

Preferably, a safety plan application system should provide an electronic database for personal treatment records to be securely available to all individuals involved in the treatment of a mentally handicapped individual and, yet would operate reliably and be manufactured at a modest expense. Thus, a need exists for a reliable safety plan application system to avoid the above-mentioned problems.

### BRIEF SUMMARY OF THE INVENTION

In view of the foregoing disadvantages inherent in the known mental health art, the present invention provides a novel safety plan application system. The general purpose of the present invention, which will be described subsequently in greater detail is to provide a system to monitor, manage and log a user's treatment and habits with mental illness.

A safety plan application system is disclosed herein, in a preferred embodiment, comprising: a safety plan application process comprising a database of stored information comprising a medication usage chart, a comprehensive behavioral log comprising a number of therapy visits, a self-evaluation mood chart, an exercise-evaluation chart, and a sleep pattern log. The safety plan application comprises the safety plan application process, wherein the safety plan application process comprises the database of stored information including the medication chart, the comprehensive behavioral log comprising the number of therapy visits, the self-evaluation mood chart, the exercise-evaluation chart, and the sleep pattern log.

The database of stored information is accessed (accessible) through a smart device, and accessible through an on-line storage system for access from a plurality of locations. The database of stored information is then shared with multiple doctors and caregivers for coordination of care by logging into the database. The medication usage chart provides data for the doctors and pharmacists to coordinate medication and provide an analysis on patient reactions to medication. Further, the medication usage chart lists allergies to avoid prescribing incorrect medication to the patient. The medication usage chart tracks dosage amount/time by an alarm for taking a prescribed medication in order to regulate mood confirming medication has been taken through said safety plan application process. The medication usage chart allows the caregivers to regulate the prescribed medication and review for possible increases and alternately increases/decreases which may be needed to the prescribed medication.

The comprehensive behavioral log includes a rating system for gauging patient mood from best to worst such that the caregiver is able to design an activity curriculum accordingly. The activity curriculum is designed to increase the patient mood in instances of a negative behavioral mood analysis. The exercise-evaluation chart comprises a plurality of suggested exercises to help the patient maintain a healthy body weight while increasing the mood of the patient. The suggested exercises included in the exercise-evaluation chart are designed to systematically elevate the self-esteem of the patient.

The safety plan application process stores the patient's favorite music lists for use with the suggested exercises. Further, the safety plan application process stores the patient's favorite inspirational quotes for assisting in increasing the mood of the patient. The safety plan application process stores the patient's legal documentation such as information regarding individuals authorized to make decisions on behalf of the patient; wherein the safety plan application process information is sent to the doctor of the patient by another the caregiver in an emergency situation for the doctor to evaluate the emergency situation immediately. The safety plan application process comprises a software application yielding a tangible result of maintaining information between a patient and all caregivers which are involved in care of the patient in case of an emergency situation.

A safety plan application system is also disclosed herein comprising a kit including: a safety plan application process software, and a set of user instructions.

A method of using a safety plan application system is also disclosed herein comprising the steps of: installing a safety plan application process, entering information on a patient into the safety plan application process, uploading the information to an on-line storage system, logging daily activities of the patient for review, and sharing the safety plan application process data with appropriate parties. The method may further comprise the step of: notifying the appropriate parties in an emergency.

The present invention holds significant improvements and serves as a safety plan application system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, safety plan application system, constructed and operative according to the teachings of the present invention.

FIG. 1 shows a perspective view illustrating a safety plan application system during an ‘in-use’ condition showing a user viewing the safety plan application process on a smart device according to an embodiment of the present invention.

FIGS. 2A-2D are perspective views illustrating the safety plan application system showing a doctor, a pharmacist, a caregiver, and a patient viewing safety plan application process information on separate smart devices via the on-line storage system according to an embodiment of the present invention of FIG. 1.

FIG. 3 illustrates the safety plan application system showing the various selectable options available for the safety plan application process according to an embodiment of the present invention of FIGS. 1-2.

FIG. 4 is a perspective view illustrating the safety plan application system showing two separate smart devices running the safety plan application receiving information from the on-line storage system according to an embodiment of the present invention of FIGS. 1-3.

FIG. 5 is a flowchart illustrating a method of use for the safety plan application system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a mental health monitoring application and more particularly to a safety plan application system as used to improve the coordination and treatment of a mentally handicapped individual.

Generally speaking, mentally handicapped patients may forget to track their medication, resulting in incorrect dosages, which can cause further imbalance. Additionally, it can be difficult for doctors to track the sleep patterns and exercise regimens of such patients, leaving them without an accurate picture of the patients' treatment. Unfortunately, without the proper treatment, patients may end up in the hospital more frequently with various complications. Further, it can be difficult and stressful for caregivers to keep important legal documents in order.

The ability to track all aspects of a mentally handicapped individual which is shared over several devices with personnel involved in care of the mentally handicapped individual would increase the likelihood of successful treatment for the mentally handicapped individual. The safety plan application process assists mentally handicapped individuals in tracking all aspects of their treatment, from medication reminders to appointments for follow up care. Appointments are crucial, especially when patients need close evaluation. The safety application process contains an alarm system which tracks all appointments, from regular doctor visits all the way to therapy/psychotherapy. An alarm will remind the mentally handicapped individual of an appointment, and an entry is necessary from the mentally handicapped individual to confirm the appointment has been attended.

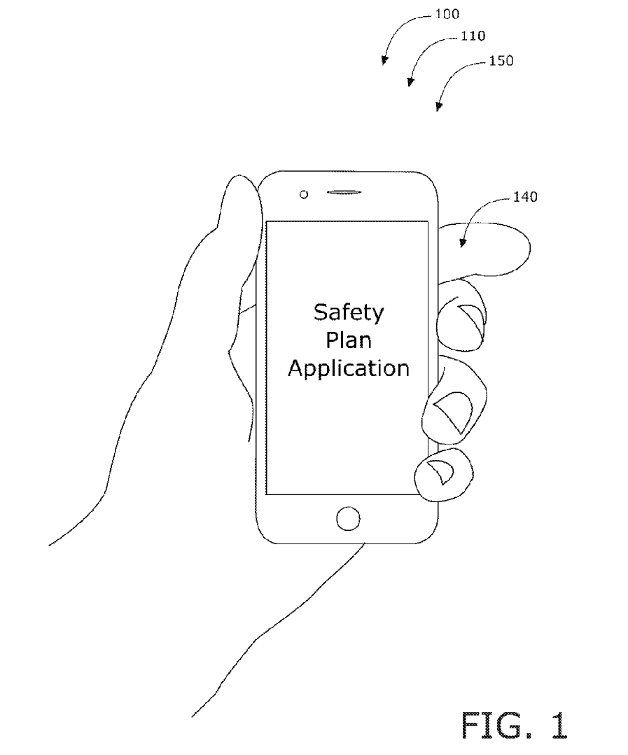

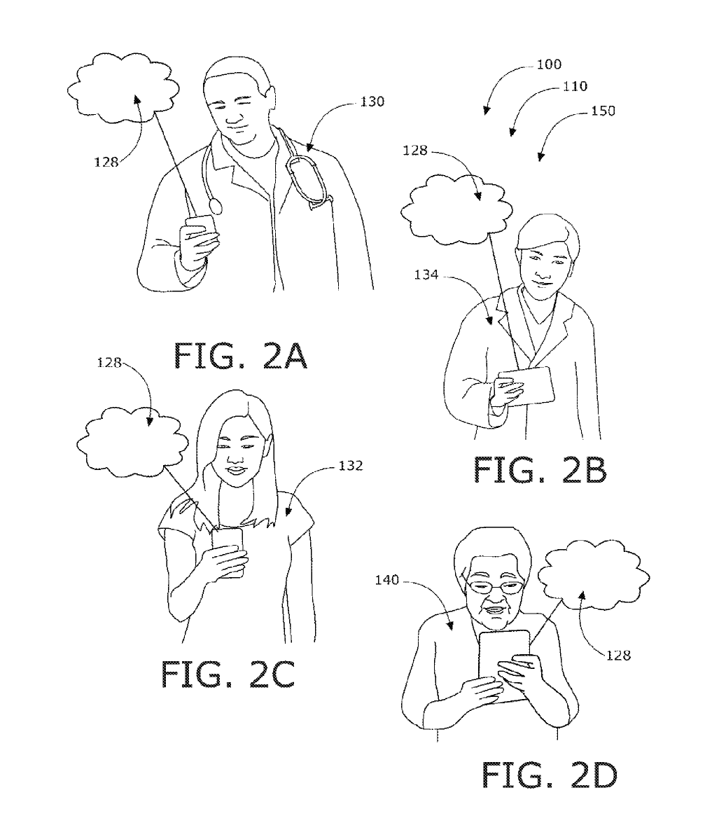

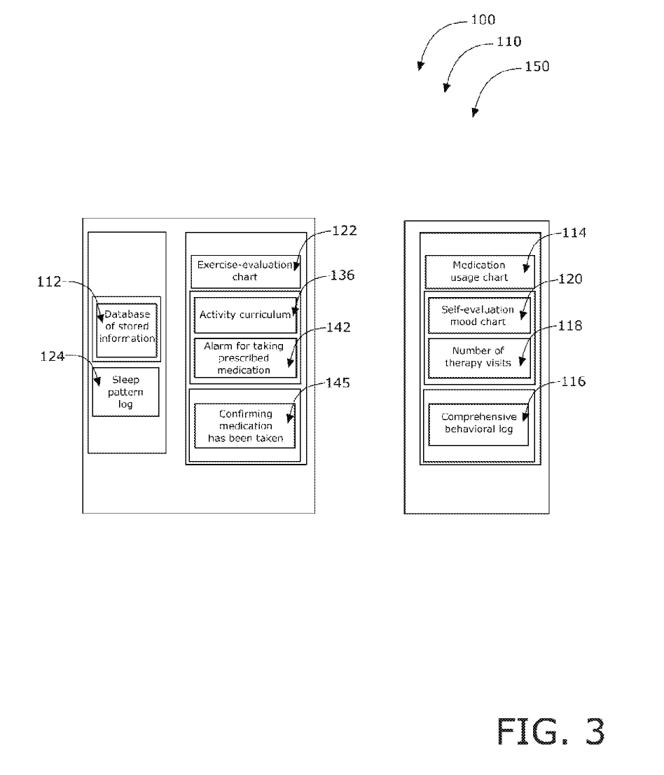

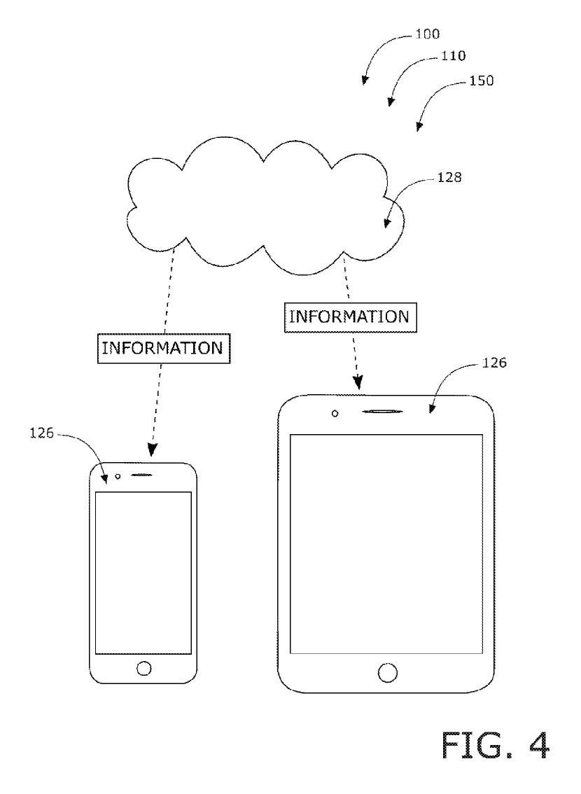

Referring to the drawings by numerals of reference there is shown in FIGS. 1-4, various views of safety plan application system 100 comprising: safety plan application process 110 comprising database of stored information 112 comprising medication usage chart 114, and comprehensive behavioral log 116 comprising number of therapy visits 118, self-evaluation mood chart 120, exercise-evaluation chart 122, and sleep pattern log 124.

Safety plan application system 100 comprises safety plan application process 110. Safety plan application process 110 comprises database of stored information 112 including medication usage chart 114, comprehensive behavioral log 116, comprising number of therapy visits 118, self-evaluation mood chart 120, exercise-evaluation chart 122, and sleep pattern log 124. Other charts and logs may be included in alternate embodiments. Safety plan application process 110 comprises a software application yielding a tangible result of maintaining information between a patient and all caregivers which are involved in care of the patient in case of an emergency situation.

Database of stored information 112 is accessible through smart device 126, and is accessible through on-line storage system 128 for access from a plurality of locations. Database of stored information 112 is shared with multiple doctors 130 and caregivers 132 for coordination of care. Medication usage chart 114 provides data for doctors 130 and pharmacists 134 to coordinate medication and provide an analysis on patient reactions to medication. Medication usage chart 114 lists allergies to avoid prescribing incorrect medication to the patient.

Medication usage chart 114 tracks dosage amount/time by an alarm for taking a prescribed medication 142 in order to regulate mood and confirming medication has been taken 145 through said safety plan application process. Further, medication usage chart 114 allows caregivers 132 to regulate the prescribed medication to review for possible increases and alternately decreases needed to the prescribed medication. Comprehensive behavioral log 116 includes a rating system for gauging patient mood from best to worst such that caregiver 132 is able to design activity curriculum 136 accordingly. Activity curriculum 136 is designed to increase mood of the patient in instances of a negative behavioral mood analysis.

Exercise-evaluation chart 122 comprises a plurality of suggested exercises to help the patient maintain a healthy body weight while increasing the patient mood. The suggested exercises included in exercise-evaluation chart 122 are designed to systematically elevate self-esteem of the patient. Safety plan application process 110 stores the patient's favorite music lists for use with the suggested exercises. Safety plan application process 110 stores the patient's favorite inspirational quotes for assisting in increasing mood of the patient. Safety plan application process 110 stores the patient's legal documentation such as information regarding individuals authorized to make decisions on behalf of the patient. Safety plan application process 110 information is sent to doctor 130 of the patient by another caregiver 132 in an emergency situation for doctor 130 to evaluate the emergency situation immediately.

It should be noted that safety plan application system 100 may be sold as kit 440 comprising the following parts: at least one safety plan application process software, and at least one set of user instructions. The kit has instructions such that functional relationships are detailed in relation to the structure of the invention (such that the invention can be used, maintained, or the like in a preferred manner). Safety plan application system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different logging/charting combinations, parts may be sold separately, etc., may be sufficient.

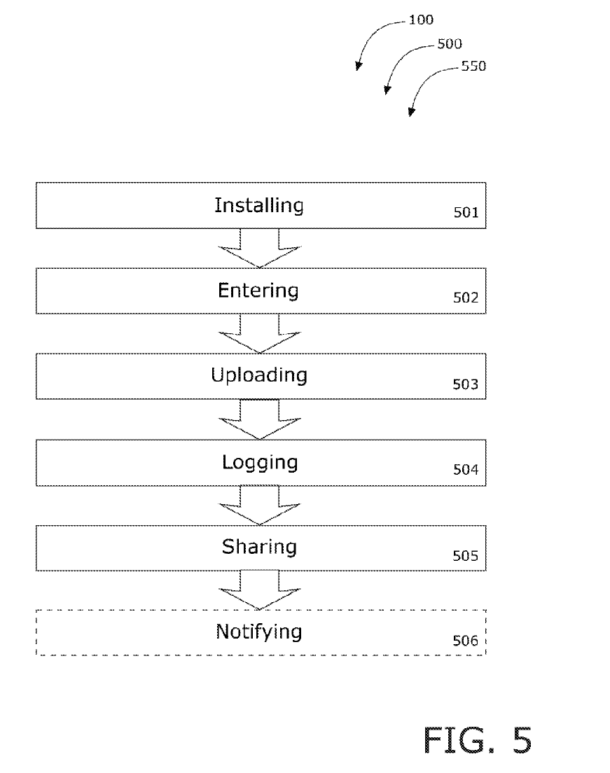

Referring now to FIG. 5 showing flowchart 550 illustrating method of use 500 for safety plan application system 100 according to an embodiment of the present invention of FIGS. 1-4.

As shown, method of use 500 may comprise the steps of: step one 501, installing a safety plan application process; step two 502, entering information on a patient into the safety plan application process; step three 503, uploading the information to an on-line storage system; step four 504, logging daily activities of the patient for review; step five 505, sharing the safety plan application process data with appropriate parties; and step six 506, notifying the appropriate parties in an emergency.

It should be noted that step 506 is an optional step and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A safety plan application system comprising:
a safety plan application process comprising;
a database of stored information comprising;
a medication usage chart;
a comprehensive behavioral log comprising;
a number of therapy visits; and
a self-evaluation mood chart;
an exercise-evaluation chart; and
a sleep pattern log;
wherein said safety plan application comprises said safety plan application process;
wherein said safety plan application process comprises said database of stored information including said medication chart, said comprehensive behavioral log comprising said number of therapy visits and said self-evaluation mood chart, said exercise-evaluation chart, and said sleep pattern log; and
wherein said safety plan application process comprises a software application yielding a tangible result of maintaining information between a patient and all caregivers which are involved in care of said patient in case of an emergency situation.

2. The safety plan application system of claim 1 wherein said database of stored information is accessed through a smart device.

3. The safety plan application system of claim 2 wherein said database of stored information is accessible through an on-line storage system for access from a plurality of locations.

4. The safety plan application system of claim 3 wherein said database of stored information is shared with multiple doctors and caregivers for coordination of care.

5. The safety plan application system of claim 1 wherein said medication usage chart provides data for said doctors and pharmacists to coordinate medication and provide an analysis.

6. The safety plan application system of claim 5 wherein said medication usage chart lists allergies to avoid prescribing incorrect medication to said patient.

7. The safety plan application system of claim 6 wherein said medication usage chart tracks dosage amount/time by an alarm for taking a prescribed medication in order to regulate mood and confirming medication has been taken through said safety plan application process.

8. The safety plan application system of claim 7 wherein said medication usage chart allows said caregivers to regulate said prescribed medication to review for possible increases and alternately decreases needed to said prescribed medication.

9. The safety plan application system of claim 1 wherein said comprehensive behavioral log includes a rating system for said patient mood from best to worst such that said caregiver is able to design an activity curriculum accordingly.

10. The safety plan application system of claim 9 wherein said activity curriculum is designed to increase mood of said patient in instances of a negative behavioral mood analysis.

11. The safety plan application system of claim 1 wherein said exercise-evaluation chart consists of a plurality of suggested exercises to help said patient maintain a healthy body weight while increasing said patient mood.

12. The safety plan application system of claim 11 wherein said suggested exercises included in said exercise-evaluation chart are designed to systematically elevate self-esteem of said patient.

13. The safety plan application system of claim 1 wherein said safety plan application process stores said patient's favorite music lists for use with said suggested exercises.

14. The safety plan application system of claim 1 wherein said safety plan application process stores said patient's favorite inspirational quotes for assisting in increasing mood of said patient.

15. The safety plan application system of claim 1 wherein said safety plan application process stores said patient's legal documentation such as information regarding individuals authorized to make decisions on behalf of said patient.

16. The safety plan application system of claim 1 wherein said safety plan application process information is sent to said doctor of said patient by another said caregiver in an emergency situation for said doctor to evaluate said emergency situation immediately.

17. A safety plan application system comprising:
a safety plan application process comprising;
a database of stored information comprising;
a medication usage chart;
a comprehensive behavioral log comprising;
a number of therapy visits; and
a self-evaluation mood chart;
an exercise-evaluation chart; and
a sleep pattern log;
wherein said safety plan application comprises said safety plan application process;
wherein said safety plan application process comprises said database of stored information including said medication chart, said comprehensive behavioral log comprising said number of therapy visits and said self-evaluation mood chart, said exercise-evaluation chart, and said sleep pattern log;
wherein said database of stored information is accessed through a smart device;
wherein said database of stored information is accessible through an on-line storage system for access from a plurality of locations;
wherein said database of stored information is shared with multiple doctors and caregivers for coordination of care;
wherein said medication usage chart provides data for said doctors and pharmacists to coordinate medication and provide an analysis;
wherein said medication usage chart lists allergies to avoid prescribing incorrect medication to said patient;
wherein said medication usage chart tracks dosage amount/time by an alarm for taking a prescribed medication in order to regulate mood and confirming medication has been taken through said safety plan application process;
wherein said medication usage chart allows said caregivers to regulate said prescribed medication to review for possible increases and alternately decreases needed to said prescribed medication;
wherein said comprehensive behavioral log includes a rating system for said patient mood from best to worst such that said caregiver is able to design an activity curriculum accordingly;
wherein said activity curriculum is designed to increase said patient mood in instances of a negative behavioral mood analysis;
wherein said exercise-evaluation chart consists of a plurality of suggested exercises to help said patient maintain a healthy body weight while increasing mood of said patient;
wherein said suggested exercises included in said exercise-evaluation chart are designed to systematically elevate self-esteem of said patient;
wherein said safety plan application process stores said patient's favorite music lists for use with said suggested exercises;
wherein said safety plan application process stores said patient's favorite inspirational quotes for assisting in increasing mood of said patient;
wherein said safety plan application process stores said patient's legal documentation such as information regarding individuals authorized to make decisions on behalf of said patient;
wherein said safety plan application process information is sent to said doctor of said patient by another said caregiver in an emergency situation for said doctor to evaluate said emergency situation immediately; and
wherein said safety plan application process comprises a software application yielding a tangible result of maintaining information between a patient and all caregivers which are involved in care of said patient in case of an emergency situation.

18. The safety plan application system of claim 17 further comprising a kit including:
said safety plan application process software; and
a set of user instructions.

19. A method of using a safety plan application system comprising the steps of:
installing a safety plan application process;
entering information on a patient into said safety plan application process;
uploading said information to an on-line storage system;
logging daily activities of said patient for review; and
sharing said safety plan application process data with appropriate parties.

20. The method of claim 19 further comprises the step of:
notifying said appropriate parties in an emergency.
